(19) United States
(12) Patent Application Publication
(10) Pub. No.: US 2005/0156403 A1
(43) Pub. Date: Jul. 21, 2005

(54) Powered kick-stand

(76) Inventors: Dan Labonte, North Bay (CA); Jeanne Labonte, North Bay (CA)

Correspondence Address: MIKE M. GAUTHIER, 959 ELISABELLA STREET, UNIT C, SUDBURY, ON, P3A 5K1, CA

(21) Appl. No.: 10/759,127

(22) Filed: Jan. 20, 2004

(51) Int. Cl. B62H 1/00

(52) U.S. Cl. 280/304

(57) ABSTRACT

A motorcycle kick-stand having an actuator implement therewith so as to enable a user to activate said kick-stand upon request. The powered kick-stand of the present invention comprises: a bike-attaching portion, a ground-contacting portion having; a foot beam, and two ground contacting feet, a control portion having; auto-switching means, a kick-up sensor, and a kick-down sensor, user switching means, and conductor means. Functionally, a user can thereby activate said bike stand by simply lowering the stand until bike is supported by said stand. Safety features implemented within the present invention include; anti-theft means by disabling the kick-up function when the bike's key is not inserted, and the system's easy lift capability, which prevents the user from having to lift the bike manually to mount it on said stand.

### FIELD OF THE INVENTION

The present invention relates to motorcycle kick-stand having an actuator implement therewith so as to enable a user to activate said kick-stand upon request. The powered kick-stand of the present invention comprises: a bike-attaching portion, a ground-contacting portion having; a foot beam, and two ground contacting feet, a control portion having; auto-switching means, a kick-up sensor, and a kick-down sensor, user switching means, and conductor means. Functionally, a user can thereby activate said bike stand by simply lowering the stand until bike is supported by said stand. Safety features implemented within the present invention include; anti-theft means by disabling the kick-up function when the bike's key is not inserted, and the system's easy lift capability, which prevents the user from having to lift the bike manually to mount it on said stand.

### BACKGROUND OF THE INVENTION

Motorcycles are undoubtedly heavy, and this commonly poses a problem when erecting the bike onto conventional double foot kick-stands. The user must pull the bike backwardly and rearwardly in order to mount said bike on a conventional kick-stand, sometimes causing bodily injury or discomfort. Furthermore, a motor bike can be relatively easily neutral-geared and stolen.

The inventor sought to provide motorcycle owners with an unobtrusive, powered kick-stand having anti-theft features while easing the erecting of said motorcycle.

The applicant is aware of attempts in prior art to provide means of powering a motor cycle kick-stand.

An example of prior art may be had when referring to U.S. Pat. No. 5,100,164 of Miyamaru, issued Mar. 31, 1992 depicting an automatic stand device for a two-wheeled vehicle, having: sensing means, which control a switch that activates of disables the lowering of a rotary-type stand depending on the bike's motion, position and state of motion. This device is rotary and requires a large amount of energy from the bike's battery to overcome the necessary force requirements in rotationally mounting a heavy bike onto such a stand.

Another example may be had in referring to U.S. Pat. No. Des. 418,089 of Jackson, issued Dec. 28, 1999, which illustrates the design of what seems to be a rotary air powered stand. However, a claim to ornamentation cannot determine functionality.

### SUMMARY OF THE INVENTION

It is thus the object of the present invention to provide motorcycle owners with an unobtrusive, powered kick-stand having anti-theft features while easing the erecting of said motorcycle.

In one aspect of the invention, an actuator is installed onto the ground-contacting portion.

In another aspect of the invention, the actuator is installed onto the bike-attaching portion.

In another aspect of the invention, sensors can include limit switches, optical or any equally suitable sensing means.

Accordingly, the system of the present invention therefore provides motorcycle owners with an unobtrusive, powered kick-stand having anti-theft features while easing the erecting of said motorcycle.

### BRIEF DESCRIPTION OF THE DRAWINGS

These and other advantages of the invention will become apparent upon reading the following brief description and upon referring to the drawings in which:—

FIG. 1 is a perspective view from above of a secondary embodiment of the powered kick-stand of the present invention.

FIG. 2 is a side elevation view of a secondary embodiment of the powered kick-stand of the present invention as installed onto a conventional motorcycle and in the “down” position.

FIG. 3 is a top plan view of a secondary embodiment of the powered kick-stand of the present invention.

FIG. 4 is a front elevation view of a secondary embodiment of the powered kick-stand of the present invention.

FIG. 5 is a side elevation view of a secondary embodiment of the powered kick-stand of the present invention.

FIG. 6 is a side elevation view taken from FIG. 3 of a secondary embodiment of the powered kick-stand of the present invention shown in the “up” position.

FIG. 7 is also a side elevation view taken from FIG. 3 of a secondary embodiment of the powered kick-stand of the present invention but shown in the “down” position.

FIG. 8 is a cross-sectional view taken from FIG. 5 drive portion of a secondary embodiment of the powered kick-stand of the present invention.

FIG. 9 is a perspective view from above of a primary embodiment of the powered kick-stand of the present invention.

FIG. 10 is a side elevation view of a primary embodiment of the powered kick-stand of the present invention in a kick-down position.

FIG. 11 is a side elevation view of a primary embodiment of the powered kick-stand of the present invention in a kick-up position.

FIG. 12 is a cross-sectional view taken from FIG. 10 of a primary embodiment of the powered kick-stand of the present invention.

FIG. 13 is a cross-sectional view taken from FIG. 12 of a primary embodiment of the powered kick-stand of the present invention.

FIG. 14 is a cross-sectional view taken from FIG. 9 of a primary embodiment of the powered kick-stand of the present invention.

FIG. 15 is a cross-sectional view taken from FIG. 14 of a primary embodiment of the powered kick-stand of the present invention.

FIG. 16 is a schematic diagram of the electrical wiring for the system of the powered kick-stand of the present invention.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

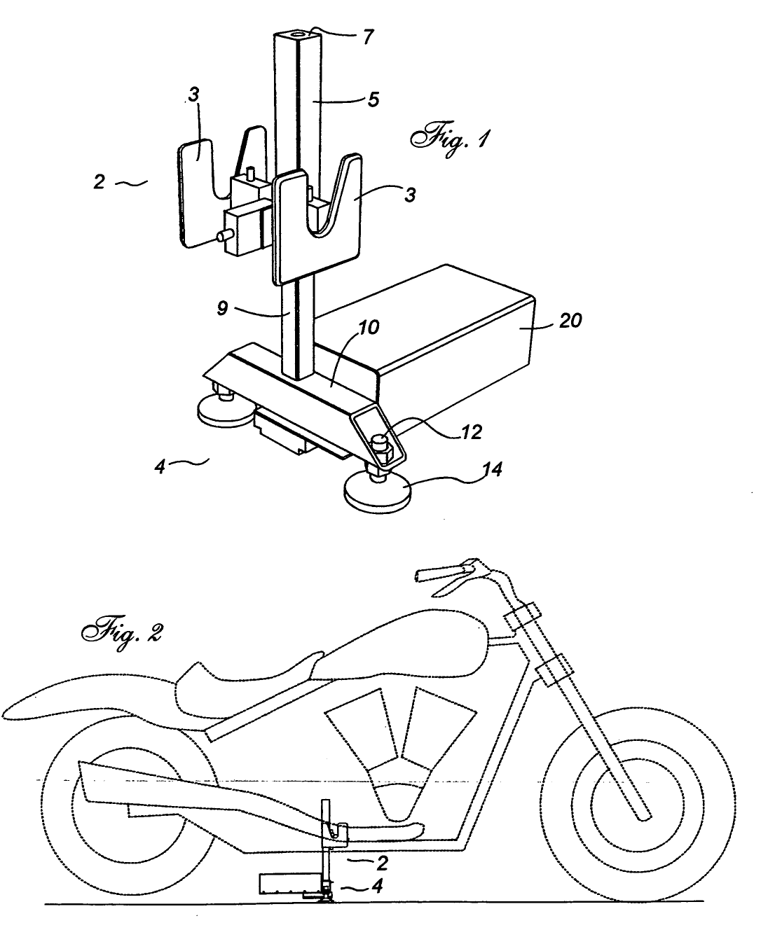

Turning to the drawings, in particular, FIG. 1, which illustrates a perspective view from above of a secondary embodiment of the powered kick-stand of the present invention showing; a motorcycle-attaching portion 2 having motorcycle-attaching members 3 fixedly attached to sidewardly extending members also fixedly attached to a vertical upper shaft 5. Said vertical upper shaft 5 having a generally square profile and a hollow interior to accept an inner drive shaft. The motorcycle-attaching portion further includes sensing means. A lower ground-contacting portion 4 comprises: a lower guide shaft 9 fixedly attached to a foot beam 10 having a generally rectangular profile and upward and inward bevels, a protrusion near each extremity of the lower portion of said foot beam 10 so as to accept threaded stems of cone shaped feet 14. An actuator housing 20 contains an electric motor and gearbox.

Turning now to FIG. 2, a side elevation view of a secondary embodiment of the powered kick-stand of the present invention illustrating its installation position relative to a conventional motorcycle. It can be seen that the motorcycle-attaching portion 2 remains fixedly attached to said motorcycle and the ground-contacting portion 4 can be raised and lowered thus engaging or disengaging the motorcycle's stance. It will be understood that either the primary or secondary embodiment shall be similarly adaptable to a motorcycle.

In reference now to FIG. 3, a top plan view of a secondary embodiment of the powered kick-stand of the present invention again illustrating another perspective of the arrangement of the various components of the system of the present invention. This Figure also illustrates the relative distance between the two ground-contacting feet 14 attached to the foot beam 10. This provides a wider stance on which the motorcycle can rest thus increasing stability of support.

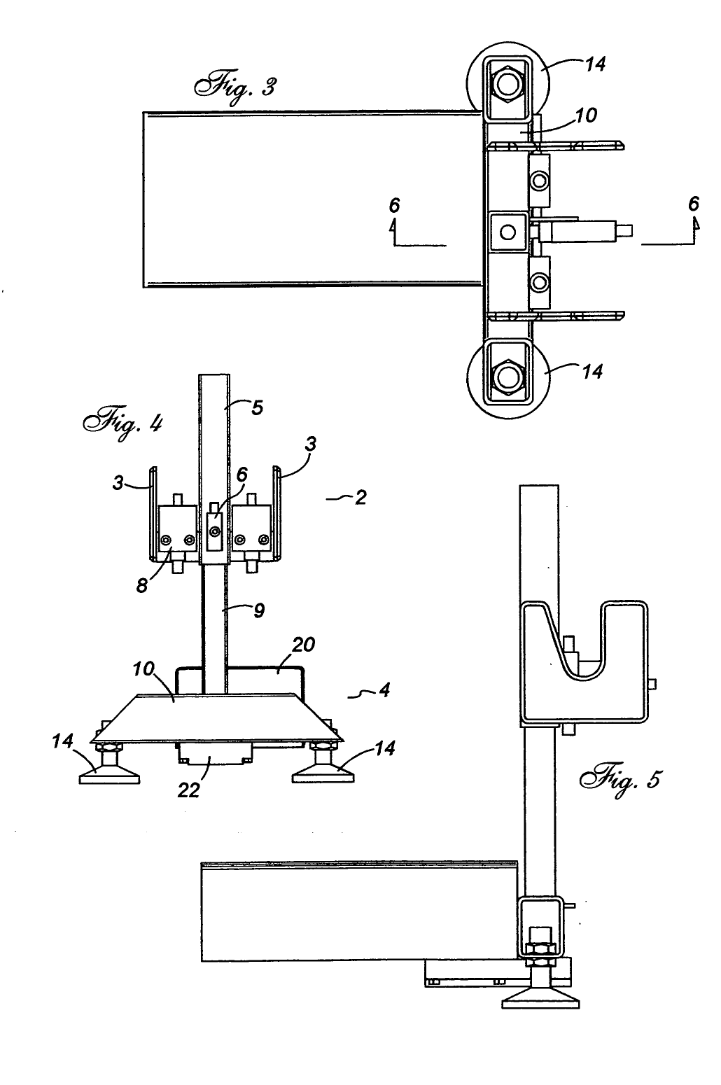

Turning now to FIG. 4, a front elevation view of a secondary embodiment of the powered kick-stand of the present invention illustrating the arrangement of the various components of the system of the present invention, including: a motorcycle-attaching portion 2 having motorcycle-attaching members 3 fixedly attached to sidewardly extending members 16 also fixedly attached to the lower portion of a vertical upper shaft 5. Said vertical upper shaft 5 having a generally square profile and a hollow interior to accept an inner drive shaft. The motorcycle-attaching portion further includes sensing means 6 and 8. A lower ground-contacting portion 4 comprising: a lower guide shaft 9 fixedly attached to a foot beam 10 having a generally rectangular profile and upward and inward bevels, a protrusion near each extremity of the lower portion of said foot beam 10 so as to accept threaded stems of cone shaped feet 14. An actuator housing 20 contains an electric motor and gearbox.

More particularly, FIG. 4 further illustrates the relative distance between the two ground-contacting feet 14 attached to the foot beam 10, providing the necessary wider stance on which the motorcycle can rest thus increasing stability and support of the motorcycle. Furthermore, when the powered kick-stand of the present invention is in the kick-down position, the motorcycle is essentially raised from the ground and virtually all of the motorcycle's weight rests upon the stand. As a security feature, the applicant believes this stand—having two feet as opposed to one side-stand—provides anti theft implements superior to any other stand in that, these two outwardly extending feet on which the motorcycle bears, restrict the ability for one to drag the motorcycle even if one attempts to tilt said motorcycle on either side.

Turning now to FIG. 5, a side elevation view of a secondary embodiment of the powered kick-stand of the present invention further illustrating the arrangement of the various components of the system of the present invention.

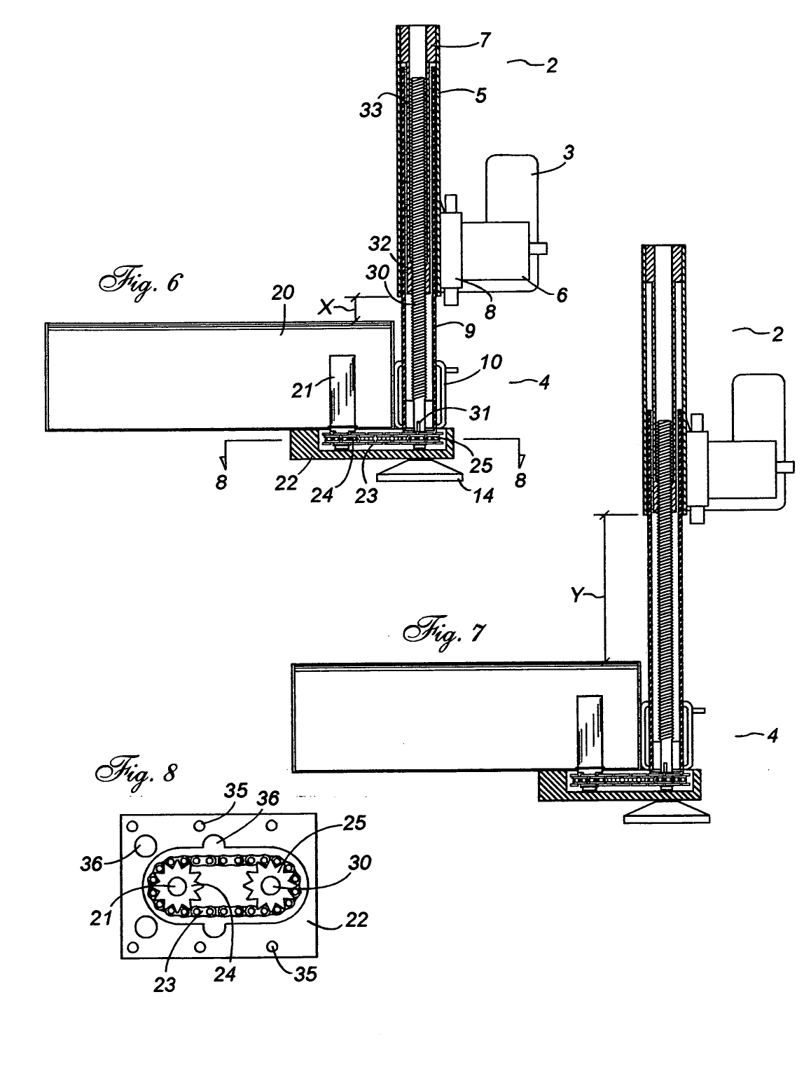

In reference now to FIG. 6, a cross-sectional view taken from FIG. 3 wherein details of inner components are more closely depicted comprising: a motorcycle-attaching portion 2 having motorcycle-attaching members 3 fixedly attached to sidewardly extending members also fixedly attached to a vertical upper shaft 5. Said vertical upper shaft 5 having a generally square profile and a hollow interior to accept an inner drive shaft 7 consisting of a tubular form having a mid section of lesser outside diameter than the inner dimension of the vertical upper shaft 5, an upper section having a generally cubic form with outer dimensions equal to the inner dimensions of the vertical upper shaft 5, and a lower section having a small portion of length treaded to mate with a drive screw 30. The motorcycle-attaching portion further includes; a lower ground-contacting portion 4 comprises: a lower guide shaft 9 having an inner dimension slightly greater than that of the outer diameter of the inner drive shaft 7 and an outer dimension slightly lesser than that of the upper vertical shaft 5, a foot beam 10 having a generally rectangular and hollow profile and upward and inward bevels at each end, a protrusion near each extremity of the lower portion of said foot beam 10 so as to accept threaded stems of cone shaped feet 14. An actuator housing 20 contains an electric motor and gearbox.

Now referring to FIG. 8, a cross-sectional view taken from FIG. 6, illustrating the drive case 22 comprising; a generally rectangular block form with a generally oblong void nearly through the height of said drive case 22. The drive case 22 houses an actuator drive shaft 21, a drive sprocket 24, a drive chain 23, and a shaft sprocket 25. The actuator drive shaft 21 therefore rotates the drive sprocket 24 in frictional communication with the drive chain 23 thus driving the shaft sprocket 25 rotationally engaged to the drive screw.

Turning again to FIG. 6, one can see that the actuator, which drives the mechanisms as described in FIG. 6 thus when the drive screw rotate, the upper motorcycle-attaching and lower ground-contacting portions move toward or away from each other creating the kick-up and/or kick-down motion as further depicted in FIG. 7.

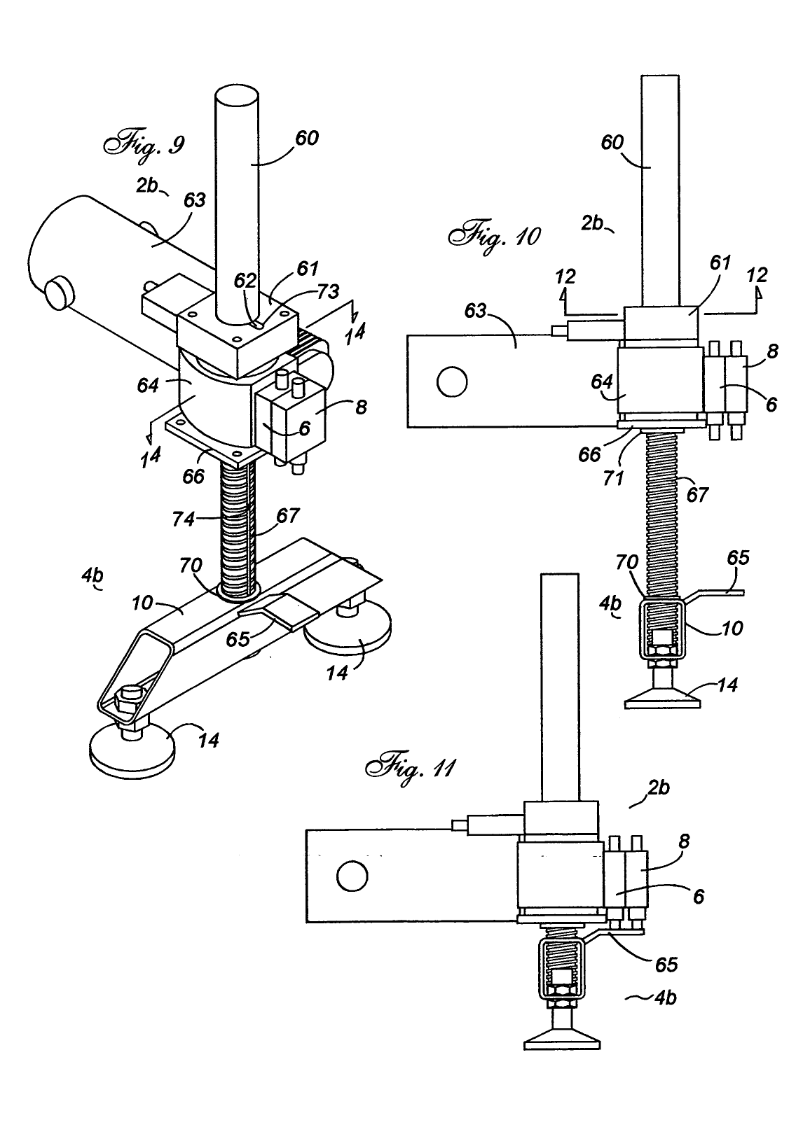

FIG. 9, a perspective view from above of a primary embodiment of the powered kick-stand of the present invention, illustrates a variation of assembly of said powered kick-stand wherein, this assembly, performing the very same function, is adapted with an actuator mechanism, which is mounted onto the bike-attaching portion 2b. A rotary actuator 63 is further adapted with a gear box 64 having a drive assembly in rotational and perpendicular communication with said actuator drive shaft. The bike-attaching portion 2b encompasses: a rotary actuator 63, a gear box 64, a drive screw cover 60, a guide block 61 having frictional attachment means for the drive screw cover 60, and a keyway 73 adapted to firmly and frictionally secure a guide key 62. Said guide block 61 is securedly attached to the gear box 64, providing a sort of extension to the gear box 64. Kick-up 8 and kick-down 6 sensors are also fixedly attached to the gear box 64. A mounting plate 66 is also fixedly and securely attached to the gear box 64. Said mounting plate 66 provides fastening means to the motorcycle, either directly or through an adapter.

In this primary embodiment, the ground-contacting portion 4b encompassed: a foot beam 10 having a generally rectangular profile and upward and inward bevels at each extremity, a protrusion near each said extremity of the lower portion of said foot beam 10 so as to accept threaded stems of cone shaped feet 14, a sensor trigger 65 fixedly attached to a central upper edge of said foot beam 10, and a drive screw 67 traversing a perforation at the top edge of foot beam 10 and fixedly attached to said foot beam 10. Therefore, the drive screw 67 and foot beam 10 are structurally assembled as one.

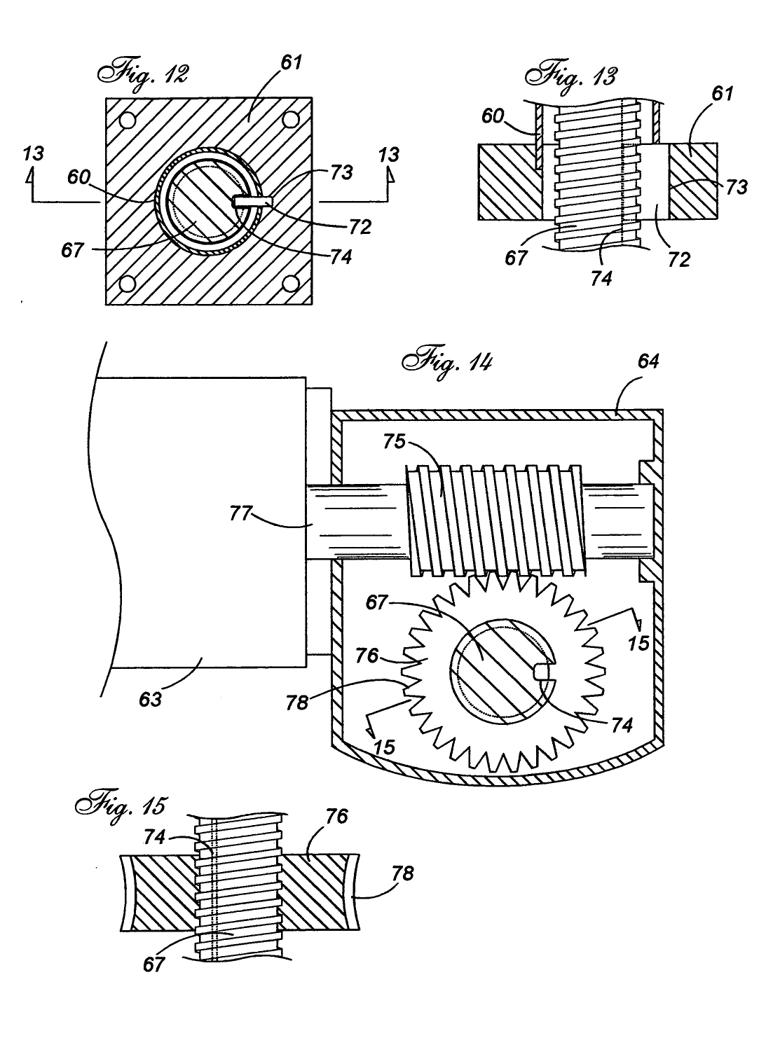

Referring now to FIG. 10, a right side elevation view of the primary embodiment of the present invention further illustrating the arrangement of the components of the present invention wherein, for clarity, we shall simultaneously turn to FIGS. 12 to 15, all cross-sectional views taken from respective FIGS. 10, 12 and 14, illustrating the functional properties of the primary embodiment of the present invention. In FIG. 14, it can be seen that the rotary actuator 63 is adapted with an actuator drive screw 75 rotationally engaged within the gear box 64, which said gear box 64 also encloses a drive gear 76 having gear teeth 78 around its circumference mating proportionately with the threads of the actuator drive screw 75 and a threaded perforation at the center of said drive gear 76 having female threads mating with male threads of the drive screw 67. The drive screw 67 is further adapted with a keyway longitudinal to the drive screw 67, which slidably mates with a key 72, frictionally and securedly engaged with the guide block 61 so as to prevent rotational motion between said guide block 61 and drive screw 67. This can be understood in referring to those FIGS. 12 to 15.

Turning back to FIG. 10, the inventor is aware that the drive screw 67 will be subjected to dirt, dust, water and other foreign objects, therefore the lowest surface of the bike-attaching portion is adapted with a semi-resilient rubber-like material mating the outer circumference of the drive screw 67 so as to keep the drive screw 67 relatively free of such undesired foreign objects.

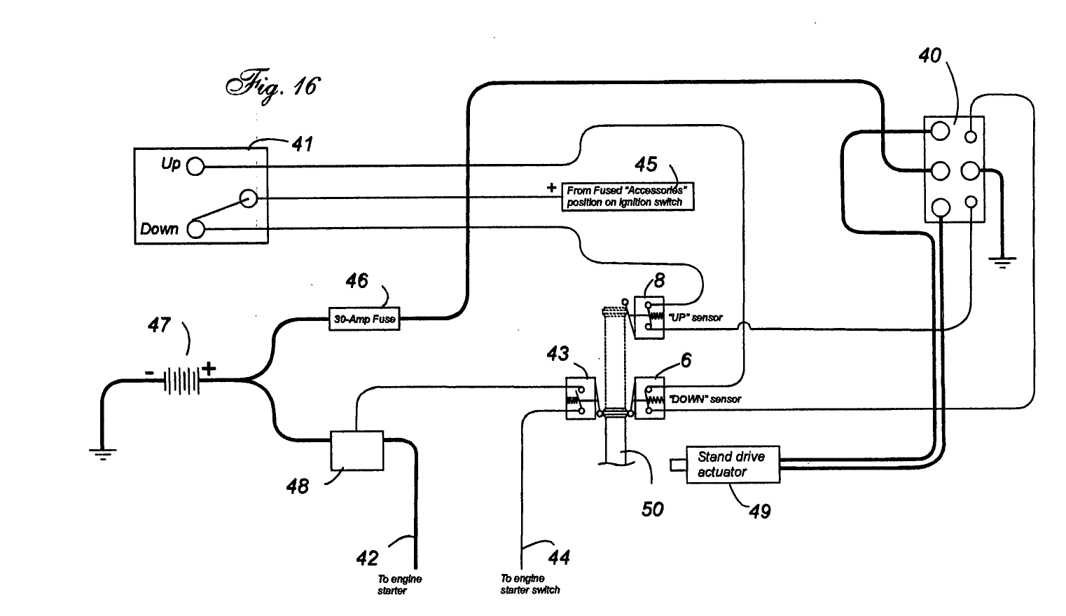

FIG. 16, a schematic diagram of the electrical wiring for the system of the powered kick-stand of the present invention simply illustrates the method used to control the motions and safety features of the present invention.

To operate, the user must place the ignition switch to “accessories” 45 or equivalent. This can only be performed with the bike's key. Furthermore, in “accessories” mode, the bike will not run, therefore the powered kick-stand will never be in a “down” position when the bike is running. This safety feature is further reinforced by use of a kick-down sensor 43 that disengages the starter relay 48 power supply. Therefore, to operate the bike, the user simply inserts the bike's key into the ignition, turns to the “accessories” mode, switches the stand to the up position 41 until the kick-up sensor senses that the stand is at the “up” position thereby re-engaging the power supply to the starter relay 48, thus allowing the bike to run. Lowering the stand cannot be performed while the bike is running since the key is not in the “accessories” mode, but once the bike is stopped or parked and the engine turned off, the user simply engages the “accessories” to lower the stand using the down position of switch 41, which activates a polarity shifter 40 thereby reversing the current polarity to the actuator.

Thus it can be seen that a motorcycle adapted with the powered kick-stand of the present invention will benefit from energy-saving easy-lifting features as a bike stand, and the benefit of theft prevention of said motorcycle.

The embodiments of the invention in which an exclusive property or privilege is claimed are defined as follows:

1. A powered kick-stand comprising:
a. a motorbike-attaching portion:
b. a ground-contacting portion;
c. actuator control means having:
i. starter switch disabling means,
ii. kick status sensors, and
iii. safety features,

2. The powered kick-stand of claim 1 wherein said stand is adapted to mount generally universally to the lower frame members of a conventional motorcycle.

3. The powered kick-stand of claims 1 and 2 wherein said stand extends directly downwardly thereby raising one or more motorbike tires off the ground.

4. The powered kick-stand of claim 3 wherein a gear box is adapted to increase the effective force from the actuator.

5. The powered kick-stand of claim 1 wherein two downwardly facing feet, distal from each other, provide a stance a sufficient width to laterally support a conventional motor bike.

6. The powered kick-stand of claims 1, 3 an 5 wherein the ground-contacting feet have generally skid-resistant lower surfaces.

7. The powered kick-stand of claims 1 through 6 wherein the utility thereof is to ease mounting of a conventional motorbike on a center stand, while providing security against theft thereof.
